(19) United States
(12) Patent Application Publication
(10) Pub. No.: US 2011/0095716 A1
(43) Pub. Date: Apr. 28, 2011

(54) MOTOR DRIVER FOR MACHINE TOOL WITH FAN MOTOR

(75) Inventors: Shigeki HANYU, Yamanashi (JP); Shinichi HORIKOSHI, Yamanashi (JP); Yasusuke IWASHITA, Yamanashi (JP)

(73) Assignee: FANUC LTD, Yamanashi (JP)

(21) Appl. No.: 12/872,301

(22) Filed: Aug. 31, 2010

(30) Foreign Application Priority Data
Oct. 26, 2009 (JP) 2009-245835

(51) Int. Cl. H02P 5/68

(52) U.S. Cl. 318/473

(57) ABSTRACT

A motor driver for a machine tool, which comprises a fan motor, configured to drive a cooling fan for cooling a radiator or the interior of the motor driver, estimates a rate of heat release within a heating element or the motor driver, based on information obtained from a motor current detector used for motor control or from an input current detector of the motor driver, and adjusts a fan motor power supply voltage to control a rotational speed of the fan motor in accordance with the estimated heat release value.

### BACKGROUND OF THE INVENTION

1. Field of the Invention

The present invention relates to a motor driver for a machine tool with a fan motor, and more particularly, to a motor driver for a machine tool having a function to control the rotational speed of a fan motor.

2. Description of the Related Art

In a motor driver comprising a fan motor configured to drive a cooling fan for cooling a radiator that radiates heat from a heating element of the motor driver or cooling the interior of the motor driver, the fan motor continues to rotate under uniform conditions after it is powered. Therefore, energy is inevitably wasted if the temperature of the radiator or within the motor driver is too low to require cooling by the cooling fan.

In order to avoid such wasteful energy consumption, the temperature of the radiator or within the motor driver is conventionally monitored by means of a temperature sensor, such as a thermostat, and the rotational speed of the fan motor is reduced by stopping the fan motor or reducing the power supply voltage.

Japanese Patent Application Laid-Open No. 2004-260112 discloses a technique in which a fan motor is controlled by monitoring the temperature based on feedback by a temperature sensor, and the fan motor is stopped at the time of polling as time-base control, whereby rotational noise can be reduced.

According to the above-described technique using the temperature sensor, the addition of the sensor unfavorably results in an increase in cost. Further, the location of the temperature sensor needs to be taken into consideration.

### SUMMARY OF THE INVENTION

Accordingly, the object of the present invention is to provide a motor driver configured so that a temperature can be estimated for speed control of a fan motor by calculating a rate of heat release within a radiator or the motor driver, based on information obtained from a motor current detector used for motor control or from an input current detector of the motor driver, in order to prevent an increase in cost due to addition of a temperature sensor.

A first form of a motor driver for a machine tool according to the present invention comprises a fan motor, configured to drive a cooling fan for cooling a radiator which radiates heat from a heating element of the motor driver for driving a motor attached to the machine tool or cooling the interior of the motor driver, a motor current detection section configured to detect a current used in current control for the motor, an estimated heat release value calculation section which calculates an estimated rate of heat release within the heating element or the motor driver, based on current information obtained from the motor current detection section, and a fan motor power supply voltage adjustment section for controlling a rotational speed of the fan motor in accordance with the estimated heat release value.

A second form of the motor driver for a machine tool according to the present invention comprises a fan motor configured to drive a cooling fan for cooling a radiator which radiates heat from a heating element of the motor driver for driving a motor attached to the machine tool or cooling the interior of the motor driver, an input current detection section configured to detect a current input to the motor driver, an estimated heat release value calculation section which calculates an estimated rate of heat release within the heating element or the motor driver, based on current information obtained from the input current detection section, and a fan motor power supply voltage adjustment section for controlling a rotational speed of the fan motor in accordance with the estimated heat release value.

In the first and second forms, the fan motor power supply voltage adjustment section can adjust a power supply voltage of the fan motor with reference to a correlation table in which the correlation between the rotational speed of the fan motor and the estimated heat release value is set in advance. Further, a power supply voltage corresponding to a predetermined rotational speed higher than a speed range in which the rotation of the fan motor is controlled can be supplied from the fan motor power supply voltage adjustment section to the fan motor at the start of the drive of the fan motor, and the speed control of the fan motor can be started in a predetermined time after the start of the motor drive.

According to the present invention arranged in this manner, there may be provided a motor driver configured so that an increase in cost due to addition of a temperature sensor can be prevented, and a temperature can be estimated for speed control of a fan motor by calculating a rate of heat release within a radiator or the motor driver, based on information obtained from a motor current detector used for motor control or from an input current detector of the motor driver.

### BRIEF DESCRIPTION OF THE DRAWINGS

FIG. 1 is a diagram illustrating a first embodiment of the present invention in which the rotational speed of a fan motor is controlled in accordance with a motor current;

FIG. 2 is a diagram illustrating the relationship between the power supply voltage and rotational speed of the fan motor according to the first embodiment;

FIG. 3 is a table illustrating correlations between the motor current, fan motor power supply voltage, and fan motor speed according to the first embodiment;

FIGS. 4A to 4C are diagrams illustrating the relationships between the motor current, fan motor power supply voltage, and fan motor speed according to the first embodiment;

FIG. 5 is a diagram illustrating a second embodiment of the invention in which the rotational speed of a fan motor is controlled in accordance with a current input to a motor driver;

FIG. 6 is a diagram illustrating the relationship between the power supply voltage and rotational speed of the fan motor according to the second embodiment;

FIG. 7 is a table illustrating correlations between the input current, fan motor power supply voltage, and fan motor speed according to the second embodiment;

FIGS. 8A to 8C are diagrams illustrating the relationships between the input current, fan motor power supply voltage, and fan motor speed according to the second embodiment; and

FIGS. 9A and 9B are diagrams illustrating how the drive of a fan motor is started at a voltage higher than the power supply voltage for speed control, and the speed control of the fan motor is started in a predetermined time after the start of the motor drive.

### DETAILED DESCRIPTION OF THE PREFERRED EMBODIMENTS

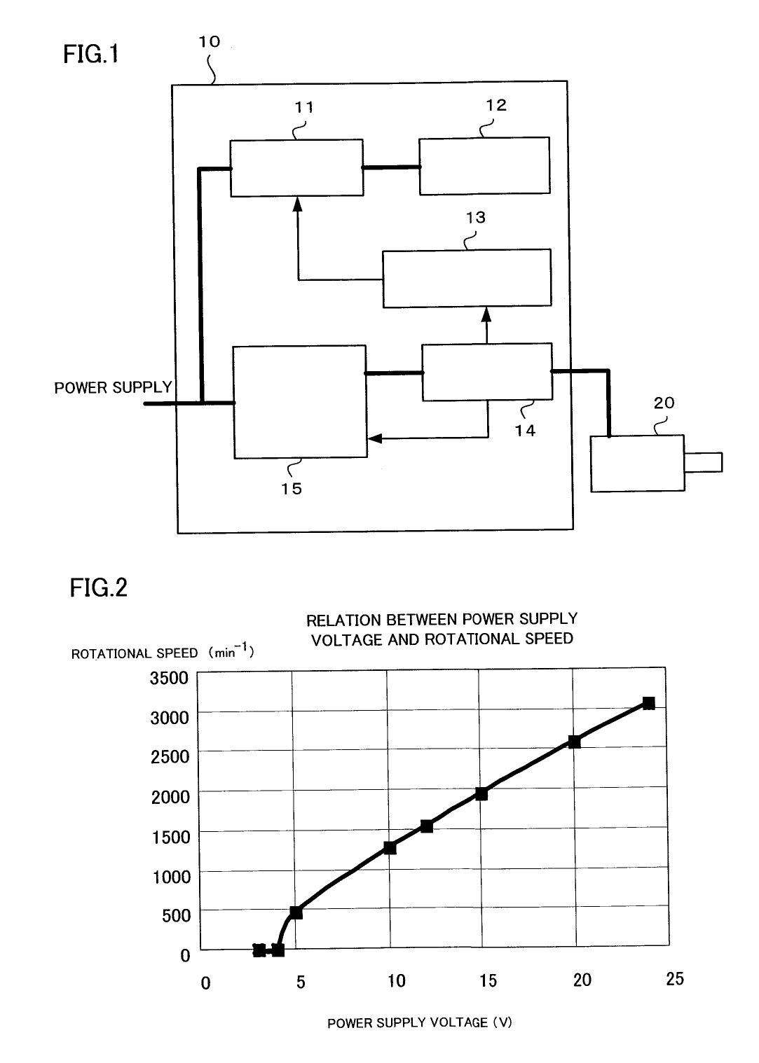

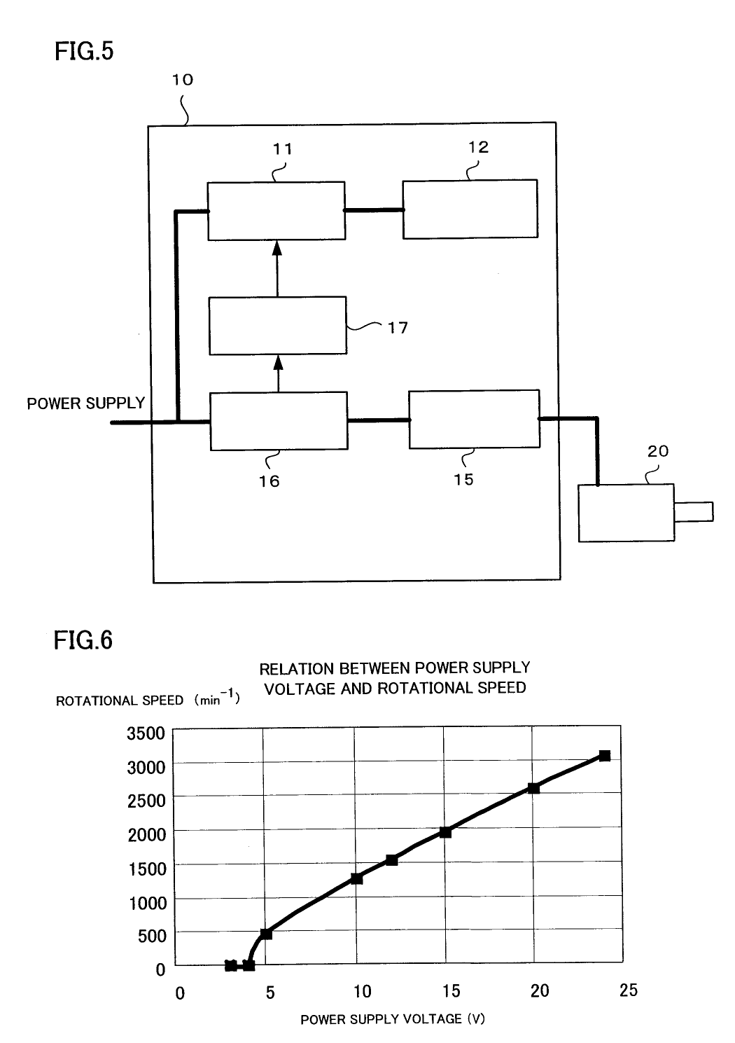

An outline of the present invention will first be described with reference to FIGS. 1 and 5.

In the present invention, the temperature of a radiator (not shown) that radiates heat from a heating element of a motor driver 10 or the internal temperature of the driver 10 is monitored, based on information obtained from a motor current detection section 14 used for motor control or an input current detection section 16 of the motor driver 10 in place of a temperature sensor. Specifically, the internal temperature of the radiator or the motor driver 10 is estimated by calculating the rate of heat release within the radiator or the driver 10 by means of a first or second estimated heat release value calculation section 13 or 17, based on the information obtained from the motor current detection section 14 or the input current detection section 16 of the motor driver 10.

Originally, the motor driver 10 is provided with the motor current detection section 14, which detects a current for controlling a motor 20. On the other hand, the input current detection section 16 is mounted as required.

If a motor current or input current is reduced, a temperature increase within the radiator or the motor driver 10 is reduced. Accordingly, a power supply voltage of a fan motor is lowered so that the rotational speed of the motor is reduced. Thereupon, wasteful energy consumption by the fan motor can be reduced in a period during which cooling is unnecessary.

In the motor driver 10 for a machine tool, moreover, dust, oil, etc., which retard rotation, adhere to the fan motor depending on the working environment, so that a high torque is required when the motor drive is started. At the start of the fan motor drive, therefore, the power supply voltage of the motor is increased to secure a necessary torque. Then, speed control is performed such that the power supply voltage of the fan motor is reduced when a steady-state speed is reached. By doing this, an energy-saving effect is expected to be obtained without failing to secure the necessary starting torque.

A first embodiment of the motor driver according to the present invention will be described with reference to FIG. 1.

A current input from the power supply to the motor driver 10 is input to a motor drive circuit 15 and converted into a current for driving the motor 20. Then, the rate of heat release within the radiator (not shown) or the motor driver 10 is estimated based on the motor current information obtained from the motor current detection section 14. Based on this “estimated heat release value”, the power supply voltage for a fan motor 12 is reduced so that a minimum necessary cooling effect can be obtained when the motor current is reduced, and the rotational speed of the fan motor 12 per unit time is reduced.

FIG. 2 is a diagram illustrating the relationship between the power supply voltage (abscissa) and rotational speed (ordinate) of the fan motor 12 according to the first embodiment. The rotational speed (min⁻¹) of the fan motor 12 increases as the power supply voltage (V) increases.

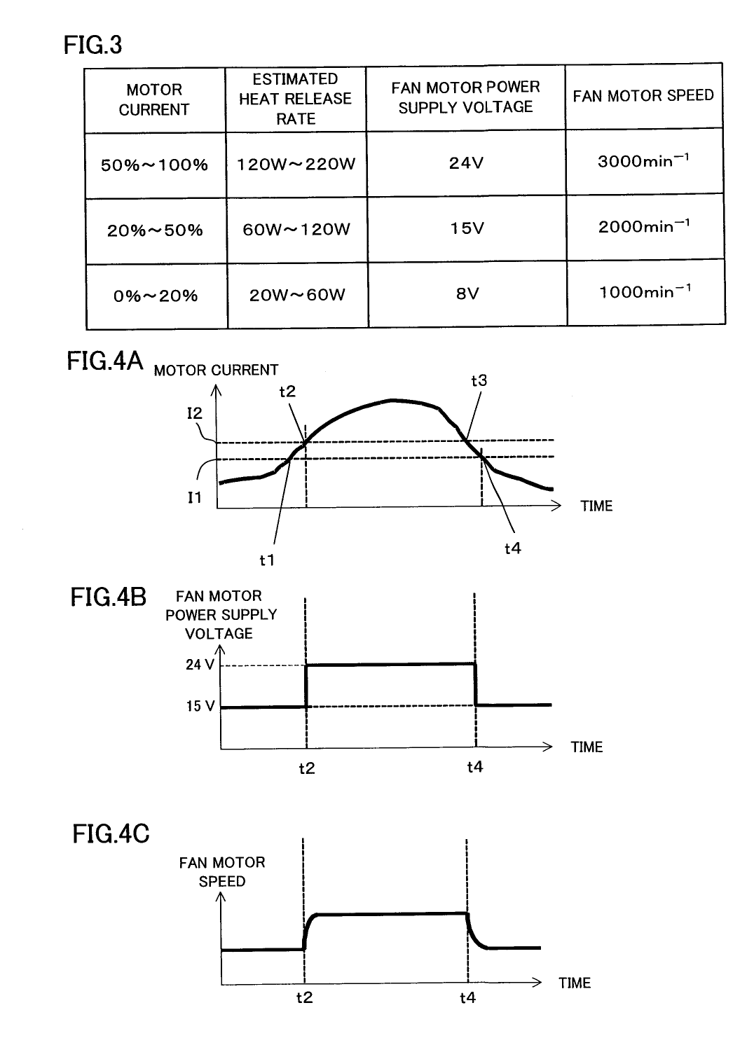

For example, the power supply voltage of the fan motor 12 is adjusted with reference to a correlation table (FIG. 3) in which the correlation between the rotational speed of the fan motor 12 and the estimated heat release value is preset. In the correlation table shown in FIG. 3, the motor current is classified in three stages, 0 to 20%, 20 to 50%, and 50 to 100%, and the power supply voltage is adjusted according to this classification of the motor current. The motor current of 100% implies the passage of the rated current of the motor 20.

If the motor current ranges from 0 to 20%, the estimated heat release value ranges from 20 to 60 W. If the power supply voltage of the fan motor 12 is 8 V, the motor speed is 1,000 rpm. If the motor current ranges from 20 to 50%, the estimated heat release value ranges from 60 to 120 W. If the power supply voltage of the fan motor 12 is 15 V, the motor speed is 2,000 rpm. If the motor current ranges from 50 to 100%, the estimated heat release value ranges from 120 to 220 W. If the power supply voltage of the fan motor 12 is 24 V, the motor speed is 3,000 rpm.

By way of example, the estimated heat release value and temperature of the radiator or the motor driver 10 can be calculated as follows:

P=a+Ka×I,

where P is the estimated heat release value (W) of the radiator or the motor driver 10, a is a steady-state heat release value (W) obtained when the motor current is not passed, I is a motor current (Arms), and Ka is a proportional constant (W/Arms).

An estimated temperature T of the radiator or the motor driver 10 relative to the estimated heat release value P (W) can be calculated as follows:

T=Kb×P+Ta,

where T is the estimated temperature within the radiator or the motor driver 10, Kb is a proportional constant (° C./W), and Ta is an ambient temperature.

In the present invention, the estimated heat release value within the radiator or the motor driver 10 is calculated based on the current (motor current) supplied to the motor 20 or the current (input current) input to the motor driver 10. The rotational speed of the fan motor 12 is controlled based on the estimated heat release value obtained by this calculation. The estimated heat release value is calculated without consideration of the ambient temperature Ta. The influence of the ambient temperature Ta can be taken into consideration by previously preparing some versions of the correlation table shown in FIG. 3 corresponding to some values of the ambient temperature Ta and selecting the correlation table corresponding to the ambient temperature Ta of the motor driver 10.

FIGS. 4A to 4C are diagrams illustrating the relationships between the motor current and the power supply voltage and rotational speed of the fan motor according to the first embodiment. As shown in FIG. 3, the power supply voltage of the fan motor 12 is adjusted in accordance with the motor current. If the motor current increases, the power supply voltage of fan motor 12 is adjusted from 15 V to 24 V. As the power supply voltage increases in this manner, the rotational speed of the fan motor 12 per unit time also increases.

FIG. 4A is a graph showing a temporal variation of the value of the motor current detected by the motor current detection section 14. As shown in FIG. 4A, the increasing motor current exceeds I1 and I2 (>I1) at times t1 and t2, respectively, and the decreasing motor current falls below I2 and I1 at times t3 and t4, respectively.

Even if the motor current increases, it is not that the temperature within the radiator or the motor driver 10 immediately increases, but that it increases with some time delay. It is necessary, therefore, only that the rotational speed of a cooling fan be increased with a predetermined time delay after the motor current is increased. If the motor current is reduced, on the other hand, it is not that the temperature within the radiator or the motor driver 10 suddenly drops.

While the motor current is increasing, therefore, the point in time when the rotational speed of the fan motor 12 for rotating the cooling fan is increased is regarded as the time when I2 is reached by the motor current value. While the motor current is decreasing, on the other hand, the point in time when the rotational speed of the fan motor 12 is reduced is regarded as the time when the motor current value is reduced to I1. Thus, a voltage of 24 V is applied to the fan motor 12 during an interval between times t2 and t4, as shown in FIG. 4B.

FIG. 4C is a graph showing a temporal change of the rotational speed of the fan motor 12 to which the voltage of 24 V is applied during the interval between times t2 and t4. Since the fan motor has a moment of inertia, the rotational speed of the fan motor increases (at time t2) and decreases (at time t4) based on a certain time constant.

A second embodiment of the motor driver according to the present invention will now be described with reference to FIG. 5.

A current input from the power supply to a motor driver 10 is input to a motor drive circuit 15 and converted into a current for driving a motor 20. Then, the rate of heat release within a radiator (not shown) or the motor driver 10 is estimated based on input current information obtained from an input current detection section 16. Based on this “estimated heat release value”, the power supply voltage for a fan motor 12 is reduced so that a minimum necessary cooling effect can be obtained when the input current is reduced, and the rotational speed of the fan motor 12 per unit time is reduced.

The “estimated heat release value” according to this second embodiment is assumed to be of substantially the same value as the “estimated heat release value” according to the first embodiment if the conversion efficiency of the motor drive circuit 15 is approximately 100%.

FIG. 6 is a diagram illustrating the relationship between the power supply voltage (abscissa axis) and rotational speed (ordinate axis) of the fan motor 12 according to the first embodiment. The rotational speed (min⁻¹) of the fan motor 12 increases as the power supply voltage (V) increases.

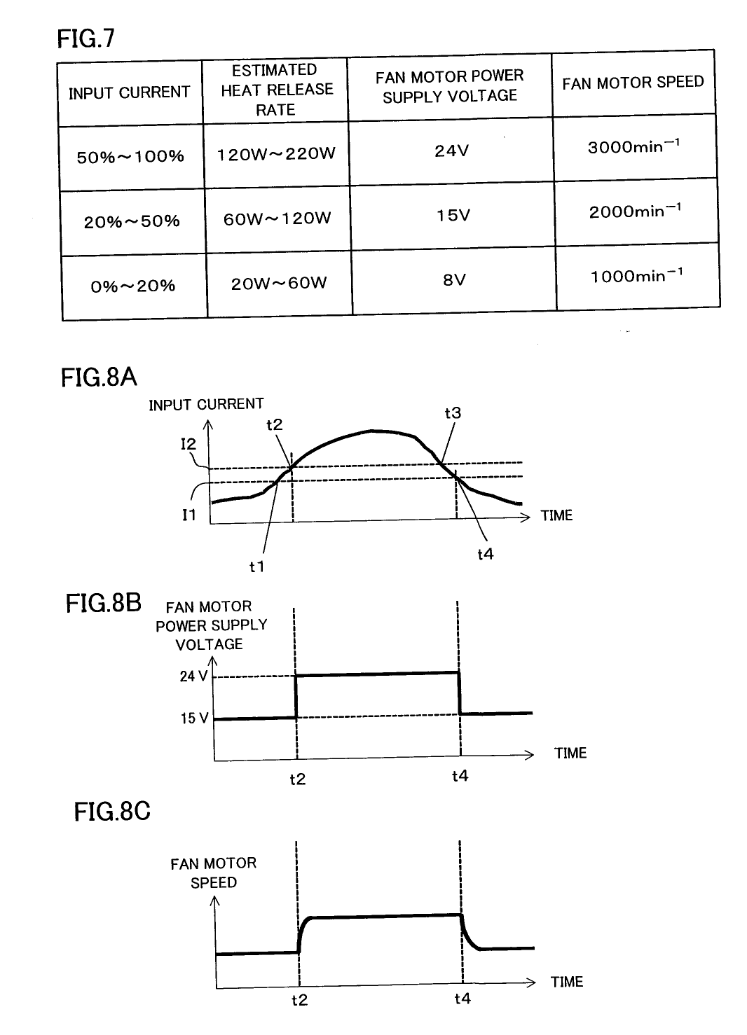

For example, the power supply voltage of the fan motor 12 is adjusted with reference to a correlation table (FIG. 7) in which the correlation between the rotational speed of the fan motor 12 and the estimated heat release value is preset. In the correlation table shown in FIG. 7, the input current is classified in three stages, 0 to 20%, 20 to 50%, and 50 to 100%, and the power supply voltage is adjusted according to this classification of the input current. The input current of 100% implies the passage of the rated current of the motor 20.

If the input current ranges from 0 to 20%, the estimated heat release value ranges from 20 to 60 W. If the power supply voltage of the fan motor 12 is 8 V, the motor speed is 1,000 rpm. If the input current ranges from 20 to 50%, the estimated heat release value ranges from 60 to 120 W. If the power supply voltage of the fan motor 12 is 15 V, the motor speed is 2,000 rpm. If the input current ranges from 50 to 100%, the estimated heat release value ranges from 120 to 220 W. If the power supply voltage of the fan motor 12 is 24 V, the motor speed is 3,000 rpm.

By way of example, the estimated heat release value and temperature of the radiator or the motor driver 10 can be calculated as follows:

P=a+Ka×I,

where P is the estimated heat release value (W) of the radiator or the motor driver 10, a is a steady-state heat release value (W) obtained when the input current is not passed, I is an input current (Arms), and Ka is a proportional constant (W/Arms).

An estimated temperature T of the radiator or the motor driver 10 relative to the estimated heat release value P (W) can be calculated as follows:

T=Kb×P+Ta,

where T is the estimated temperature within the radiator or the motor driver 10, Kb is a proportional constant (r/W), and Ta is an ambient temperature.

In the present invention, as mentioned before, the estimated heat release value within the radiator or the motor driver 10 is calculated based on the current (motor current) supplied to the motor 20 or the current (input current) input to the motor driver 10. The rotational speed of the fan motor 12 is controlled based on the estimated heat release value obtained by this calculation. The estimated heat release value is calculated without consideration of the ambient temperature Ta. The influence of the ambient temperature Ta can be taken into consideration by previously preparing some versions of the correlation table shown in FIG. 3 or 7 corresponding to some values of the ambient temperature Ta and selecting the correlation table corresponding to the ambient temperature Ta of the motor driver 10.

FIGS. 8A to 8C are diagrams illustrating the relationships between the input current and the power supply voltage and rotational speed of the fan motor 12 according to the second embodiment. As shown in FIG. 7, the power supply voltage of the fan motor 12 is adjusted in accordance with the input current. If the input current increases, the power supply voltage of fan motor 12 is adjusted from 15 V to 24 V. As the power supply voltage increases in this manner, the rotational speed of the fan motor 12 per unit time also increases. Since the control of the rotational speed of the fan motor 12 is the same as that described with reference to FIGS. 4A to 4C, a description thereof is omitted.

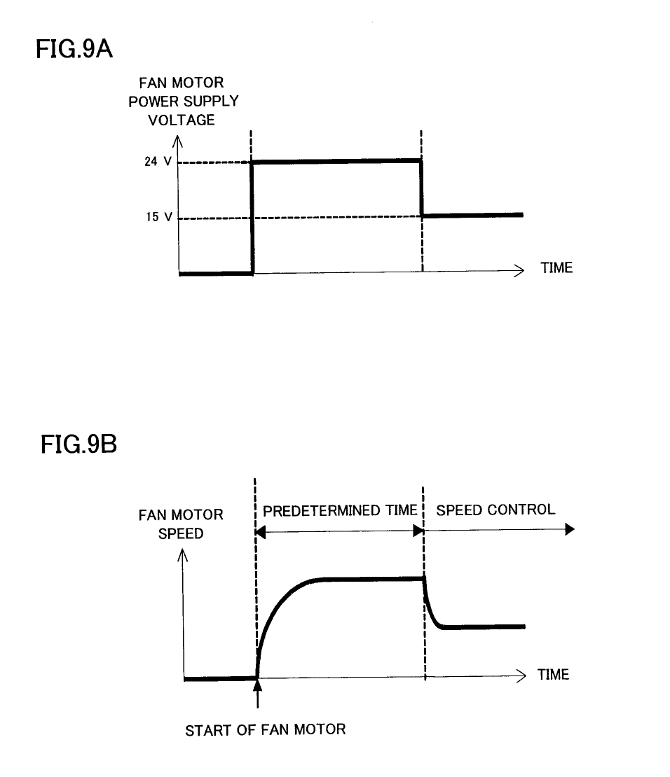

A third embodiment will now be described with reference to FIGS. 9A and 9B.

FIGS. 9A and 9B are diagrams illustrating how the drive of a fan motor is started at a voltage higher than the power supply voltage for speed control, and the speed control of the fan motor is started in a predetermined time after the start of the motor drive. In the example shown in these diagrams, the power supply voltage range for the speed control is set to 0 to 15 V, and the starting voltage of the fan motor 12 to 24 V.

In the motor driver 10 for a machine tool, moreover, dust, oil, etc., which retard rotation, adhere to the fan motor 12 depending on the working environment, so that a high torque is required when the motor drive is started. At the start of the fan motor drive, therefore, the power supply voltage of the motor is increased to secure a necessary torque. Then, speed control is performed such that the power supply voltage of the fan motor 12 is reduced when a steady-state speed is reached. By doing this, an energy-saving effect can be obtained without failing to secure the necessary starting torque.

What is claimed is:

1. A motor driver for a machine tool, which comprises a fan motor, configured to drive a cooling fan for cooling a radiator which radiates heat from a heating element of the motor driver for driving a motor attached to the machine tool or cooling the interior of the motor driver, and a motor current detection section configured to detect a current used in current control for the motor, the motor driver further comprising:
an estimated heat release value calculation section which calculates an estimated rate of heat release within the heating element or the motor driver, based on current information obtained from the motor current detection section; and
a fan motor power supply voltage adjustment section for controlling a rotational speed of the fan motor in accordance with the estimated heat release value.

2. The motor driver for a machine tool according to claim 1, wherein the fan motor power supply voltage adjustment section adjusts a power supply voltage of the fan motor with reference to a correlation table in which the correlation between the rotational speed of the fan motor and the estimated heat release value is set in advance.

3. The motor driver for a machine tool according to claim 2, wherein a power supply voltage corresponding to a predetermined rotational speed higher than a speed range in which the rotation of the fan motor is controlled is supplied from the fan motor power supply voltage adjustment section to the fan motor at the start of the drive of the fan motor, and the speed control of the fan motor is started in a predetermined time after the start of the motor drive.

4. A motor driver for a machine tool, which comprises a fan motor configured to drive a cooling fan for cooling a radiator which radiates heat from a heating element of the motor driver for driving a motor attached to the machine tool or cooling the interior of the motor driver, the motor driver further comprising:
an input current detection section configured to detect a current input to the motor driver;
an estimated heat release value calculation section which calculates an estimated rate of heat release within the heating element or the motor driver, based on current information obtained from the input current detection section; and
a fan motor power supply voltage adjustment section for controlling a rotational speed of the fan motor in accordance with the estimated heat release value.

5. The motor driver for a machine tool according to claim 4, wherein the fan motor power supply voltage adjustment section adjusts a power supply voltage of the fan motor with reference to a correlation table in which the correlation between the rotational speed of the fan motor and the estimated heat release value is set in advance.

6. The motor driver for a machine tool according to claim 5, wherein a power supply voltage corresponding to a predetermined rotational speed higher than a speed range in which the rotation of the fan motor is controlled is supplied from the fan motor power supply voltage adjustment section to the fan motor at the start of the drive of the fan motor, and the speed control of the fan motor is started in a predetermined time after the start of the motor drive.
